(19) United States
(12) Patent Application Publication
(10) Pub. No.: US 2009/0014223 A1
(43) Pub. Date: Jan. 15, 2009

(54) Differential for a lightweight vehicle

(76) Inventors: Robert M. Jones, Brooksville, FL (US); Bruce L. VanHoozen, Brooksville, FL (US); Jesse H. Sims, Brooksville, FL (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/825,846

(22) Filed: Jul. 9, 2007

(51) Int. Cl. B60K 17/16; B60K 1/02

(52) U.S. Cl. 180/65.8; 180/65.1; 903/903

(57) ABSTRACT

A differential for a vehicle having a suspension includes a first axle shaft, and a second axle shaft. The first axle shaft and the second axle shaft are disposed along a first axis of rotation. A first electric motor is disposed along a second axis of rotation. The second axis of rotation is spaced from the first axis of rotation. A housing is configured to support the first and second axle shafts. The shafts are disposed in a transverse manner through the housing. The first electric motor is also disposed in a transverse manner through the housing. The housing is configured to support the first electric motor as sprung weight, and in a location below the vehicle.

### BACKGROUND OF THE INVENTION

An apparatus for controlling an electric motor is known in the art. One apparatus for controlling an electric motor includes U.S. Pat. No. 7,071,642 B2 to Wilton et al. (hereinafter referred to as “Wilton”). Wilton discloses a hybrid vehicle with a number of traction drive units, or electric motors to propel the vehicle. The hybrid vehicle includes a controller that may shift torque to one electric motor, or reduce power to one electric motor, when certain detected conditions are sensed.

Wilton at FIG. 1 discloses numerous assemblies for the hybrid vehicle including a traction drive unit. The unit includes a permanent magnet brushless direct current motor, which is connected to a battery. The battery is also connected to a generator in the engine. An electric motor is directly connected to each wheel by a gear box.

This arrangement is disfavored since consumers would tend to want a more compact arrangement, where multiple electric motors may be used, and be supported by the suspension in one central location, instead of adding to the mass of the suspension components themselves including the wheels (and rather than having a heavy unsprung weight in four different locations), which may provide for poor on road and off road performance. The larger ratio of sprung weight to unsprung weight, the less the body and the driver is affected by bumps, dips, and road imperfections. The more sprung weight, the better the ride of the vehicle. Accordingly, there is a need in the art for a differential suitable for a lightweight that remedies these deficiencies in the art.

### SUMMARY OF THE INVENTION

A differential for a vehicle having a suspension includes a first axle shaft, and a second axle shaft with the first axle shaft and the second axle shaft disposed along a first axis of rotation. A first electric motor is disposed along a second axis of rotation, and is positioned spaced from the first axis. A housing is configured to support the first and second axle shaft, which are disposed in a transverse manner through the housing. The first electric motor is also disposed in a transverse manner through the housing. The housing is configured to support the first electric motor as sprung weight and with this arrangement, less weight is on the wheels, and the vehicle handles better.

In another embodiment, there is provided a differential for a vehicle having a suspension. The differential includes a first axle shaft, and a second axle shaft. The first axle shaft and the second axle shaft are disposed along a first axis of rotation. The differential also has a first electric motor, and a second electric motor. The first and the second electric motors are disposed along a second axis of rotation that is spaced from the first axis in a rear of the first and second axle shafts. The first and second electric motors are generally positioned in a parallel manner with regard to a position of the first axle shaft and the second axle shaft. The differential also includes a housing with the first and second axle shaft disposed transverse through the housing. The first and second electric motors are also disposed in a transverse manner through the housing. The housing is configured to support the first and the second electric motors so that the first and second electric motors are supported as sprung weight, and in a low position with a low center of gravity, and under the vehicle.

A method of transmitting power to at least a first and second wheel and allowing the first and second wheels to rotate at different speeds relative to one another is also provided. The method includes providing a first axle shaft connected to the first wheel and providing a second axle shaft connected to the second wheel. The first axle shaft and the second axle shaft are disposed along a first axis of rotation. The method also includes supporting the first and second axle shaft in a transverse manner along the first axis of rotation, and providing at least one electric motor along a second axis of rotation spaced from the first axis of rotation. The first electric motor is supported transversely, and spaced from the first and the second axle shaft. The electric motor is supported as sprung weight, and in a low position located underneath the vehicle.

A transmission for a single wheel of a four wheeled vehicle having a suspension is also provided. The transmission includes a first axle shaft, and a second axle shaft with the first axle shaft and the second axle shaft both disposed along a first axis of rotation. A first electric motor is disposed along a second axis of rotation, and is spaced from the first axis. The motor is connected to the first axle shaft by a geared arrangement. A housing supports the first and second axle shafts in a transverse manner through the housing.

The housing also supports the first electric motor in a transverse manner through the housing with the housing configured to support the first electric motor as sprung weight. The transmission also includes a battery, which is operatively connected to the first electric motor and also has a controller. The controller receives at least one input signal relating to a parameter of the vehicle. The controller receives the at least one input signal, and outputs a control signal in response to the input signal to control an output of the electric motor. The electric motor in response to the control signal rotates the geared arrangement to rotate at least one of the first axle shaft or the second axle shaft at a predetermined rate of rotation depending on the input signal.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 shows a perspective view of an apparatus for mimicking a differential for a vehicle;

FIG. 2 shows a side view of the apparatus of FIG. 1;

FIG. 3 shows a rear view of the apparatus of FIG. 1;

FIG. 4 shows a top view of the apparatus of FIG. 1 supported as sprung weight in an all-terrain vehicle;

FIG. 5A shows an exploded view of the apparatus of FIG. 1;

FIG. 5B shows a close up view of one geared arrangement of FIG. 5A;

FIG. 6A shows an embodiment of the differential for a four wheel drive vehicle;

FIG. 6B shows an alternative embodiment of the differential of FIG. 6A with a single unitary housing for supporting the four electric motors;

FIG. 7 shows another alternative embodiment of the apparatus of FIG. 1 showing the apparatus configured for operation as a transmission;

FIG. 8 shows a method of controlling the first and the second electric motors of FIG. 1 according to one embodiment the present disclosure; and

FIG. 9-11 show another embodiment of the differential of the present disclosure with a CV joint.

### DETAILED DESCRIPTION OF THE INVENTION

A description of example embodiments of the invention follows.

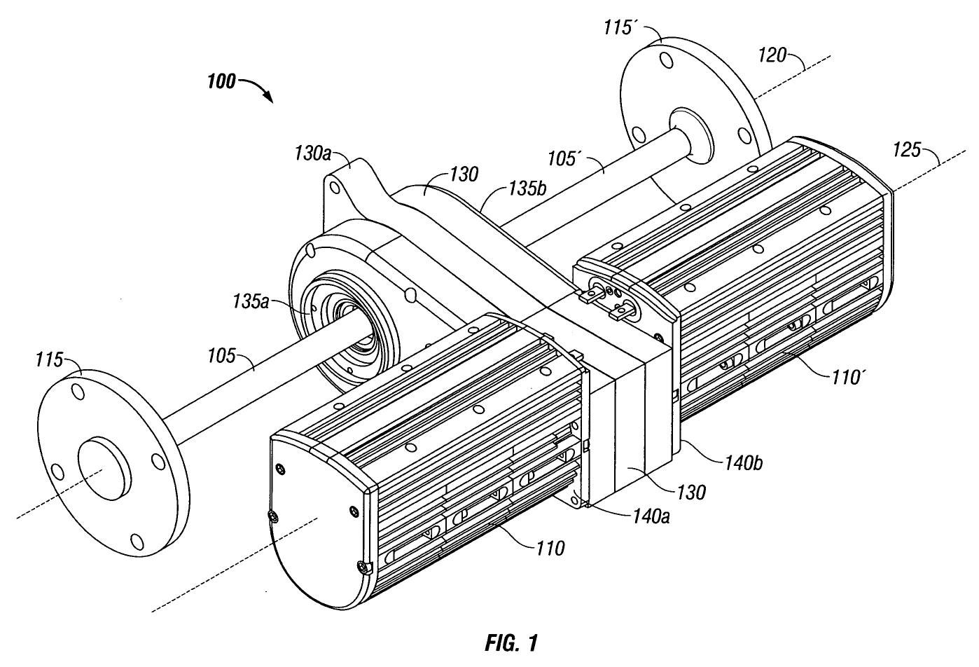

Turning to FIG. 1, there is show a perspective view according to a first embodiment for a differential 100 for a vehicle having a suspension. It should be appreciated that vehicles, which include a suspension include two types of supported weight or mass, the unsprung weight, and the sprung weight. The unsprung weight is defined as the weight of the mass that is directly connected to the suspension, rather than the weight that is supported by the suspension.

Examples, of sprung weight include components supported by the suspension including the cabin, the frame, body of the vehicle, engine, power train above the wheels, and electric batteries, among other components which may specifically depend upon the vehicle. Unsprung weight includes the mass of components, such as, for example, the wheel spindles, wheel bearings, tires, and a portion of the weight of the drive shafts, springs, shock absorbers, and suspension links. If the vehicle's brakes are mounted outboard (i.e., within the wheel), their weight is also part of the unsprung weight. The ratio of unsprung weight to sprung weight is critical in the performance of the vehicle and is critical to the ride of the vehicle.

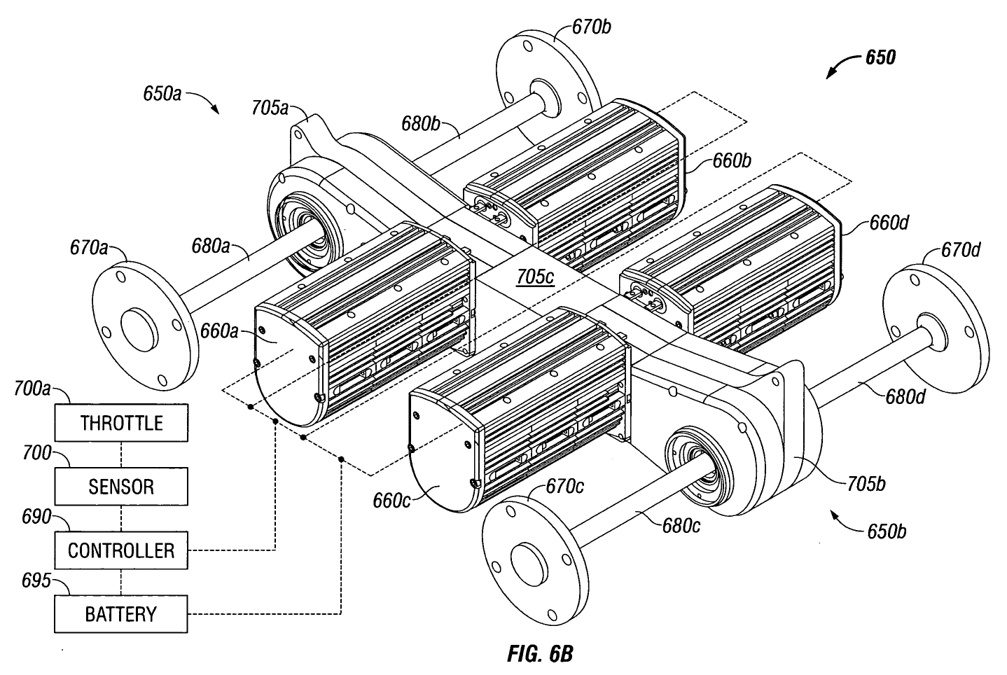

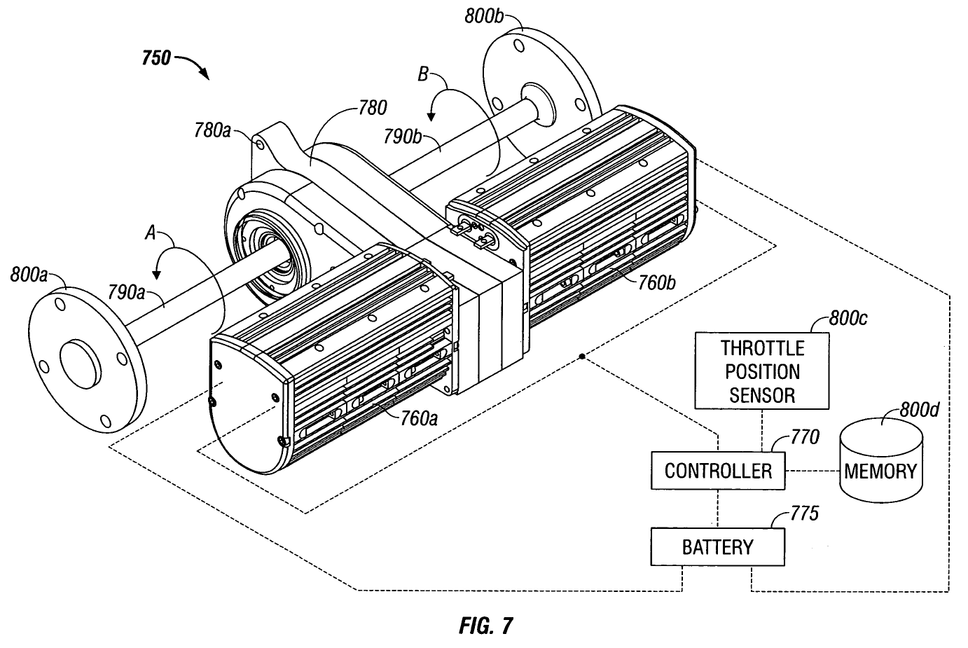

The present differential 100 preferably mimics an automotive differential. The differential preferably can rotate one drive axle shaft 105 at a different speed, or rate of rotation, relative to a second drive axle shaft 105′. This occurs while transmitting power to both drive axle shafts 105, 105′ from at least one or both electric motors 110, 110′, or even from four different electric motors during four wheel operation to wheels 115, 115′ and to another set of wheels as shown in FIGS. 6A and 6B. Preferably, one motor 110 drives independently one wheel 115; however, this arrangement is not limiting.

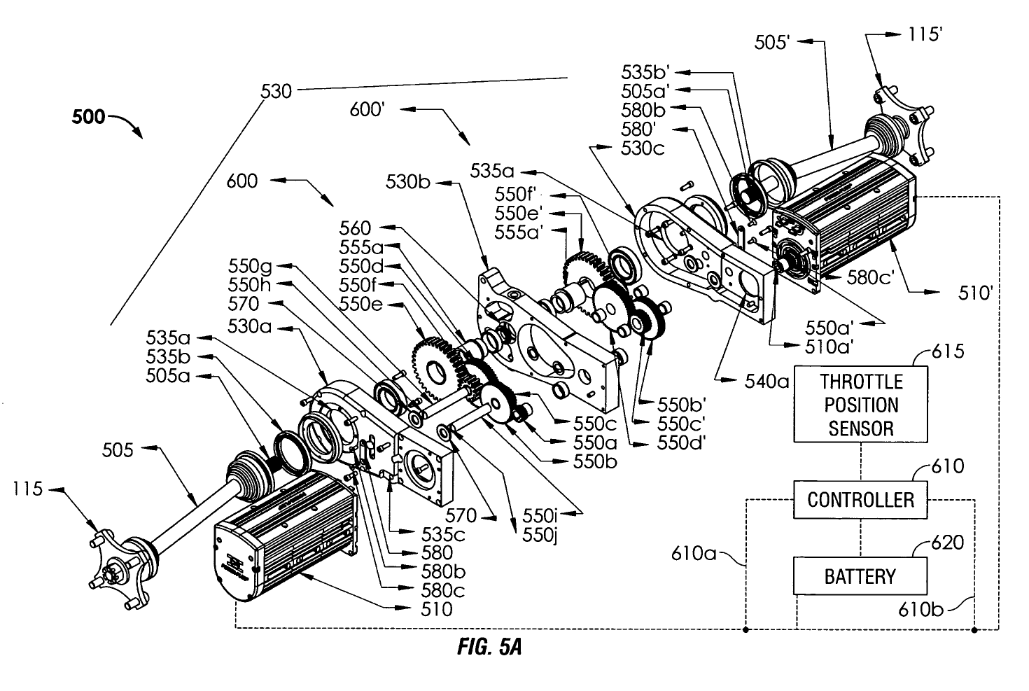

Referring to FIG. 1 through 4, there is shown a differential 100 for a vehicle V (FIG. 4) with a body and suspension. The vehicle V is shown with various other assemblies removed for illustration purposes. It should be appreciated that the present differential 100 may be used with a lightweight gas powered vehicle, a truck, a car, an electric vehicle, a golf cart, or any other vehicle or hybrid vehicle operated by (or assisted with) one or more electric motors. The differential 100 includes a first axle shaft 105, and a second axle shaft 105′ with the first and the second axle shafts 105, 105′ being disposed generally along a first axis of rotation 120. Disposed in a rear of the first axis of rotation 120 is a second axis of rotation 125, which is spaced from the first axis of rotation 120, and where at least one electric motor 110 or 110′ is positioned generally parallel to the first axis of rotation 120. Operation with one or two electric motors 110, and 110′ can be made, and the present differential 100 is not limited to any configuration, although, one motor 110, 110′ per wheel is preferred for one application.

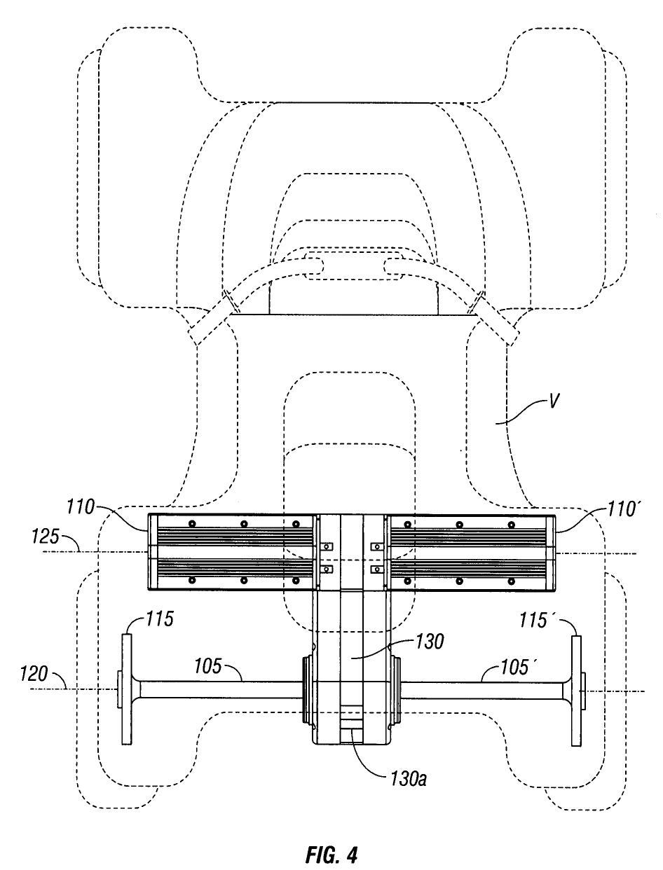

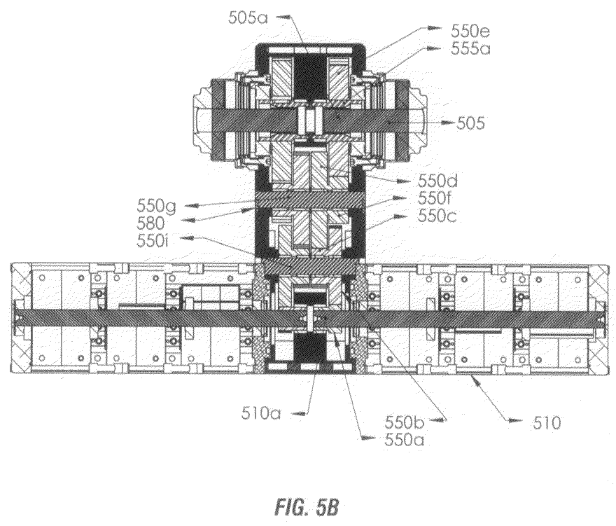

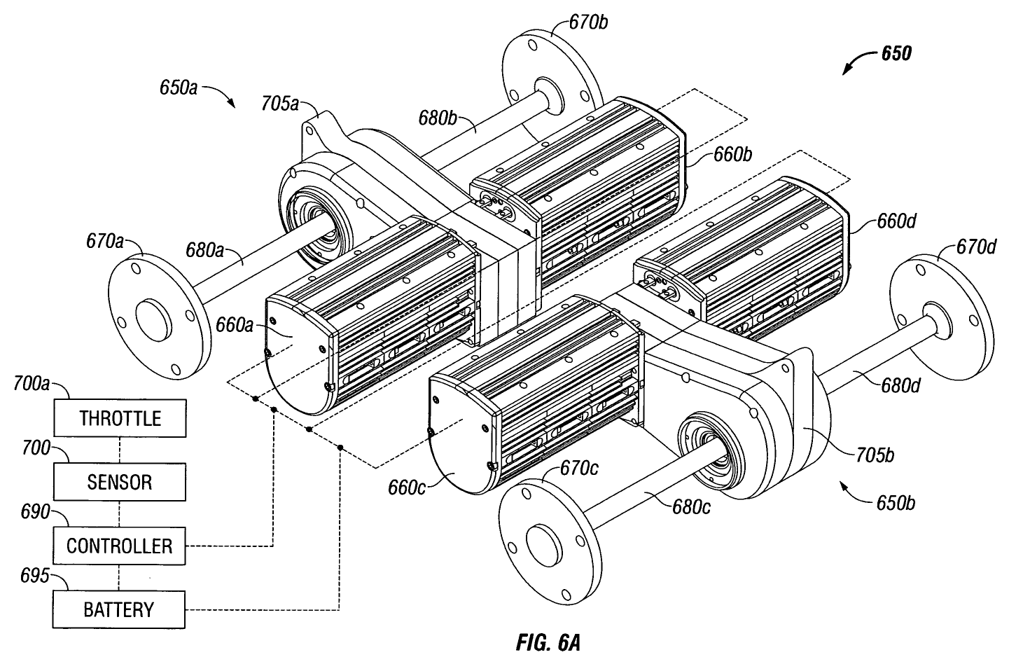

The differential 100 also includes a gear box, or housing 130 that is disposed generally transverse to the first axis of rotation 120, and generally transverse relative to the second axis of rotation 125. The housing 130 is generally rectangular shaped and is located between the first and the second electric motors 110, 110′, and is intended to be located underneath the vehicle in a low location that is disposed slightly above the ground as shown in FIG. 3. Housing 130 is intended to be made from a durable, lightweight, and resilient material so as to prevent being damaged during high speed use as the vehicle moves. Housing 130 also includes a height that is suitable to generally conform with the height of the first and the second electric motors 110, 110′ so as to be below the vehicle in a compact configuration. Preferably, the housing 130 includes a raised section 130a. Raised section 130a preferably permits selectively fastening of the raised section 130a of housing 130 to a receiving portion (not shown) or joint of the vehicle and as shown in FIG. 4. Other connection arrangements are possible and within the scope of the present disclosure, and the raised section vehicle connection point 130a is not limiting as it may be connected to the frame, chassis, or portion of the block. Preferably, a post 535c also fastens the differential 100 to the vehicle, and will be discussed in FIG. 5A.

Housing 130 also includes a pair of apertures 135a, 135b (shown in FIG. 1) for receiving the respective first axle shaft 105, and for receiving the second axle shaft 105′. The housing 130 also includes rear apertures 140a, 140b (shown in FIG. 1) for receiving the first electric motor 110, and the second electric motor 110′ with the first and the second electric motors 110, 110′ being disposed in the rear and connected to the housing 130, while being spaced sufficiently from the first axis of rotation 120. It should be appreciated that two motors 110, 110′ may be used, and supported on the housing 130. Alternatively, although it is preferred that one motor 110 drives one wheel 115, one electric motor 110 may be used with a geared arrangement (not shown) that is configured to selectively direct torque to more than one wheel 115, 115′. The present invention is not limited to using two electric motors 110, 110′, and may be used with one, two, three, four or more electric motors.

In another alternative embodiment, a vehicle may include two differentials 100 (as shown in FIGS. 6A and 6B) using four electric motors 110, 110′ for four wheel drive powered operation. Here, the four electric motors provide torque to four wheels. Turning again to FIG. 1, the differential 100 may include motors 110, 110′, which may be any one of switched reluctance motors, permanent magnet electric motors, alternating current synchronous electric motors, servo-electric motors, induction electric motors, brushless permanent magnet direct current motors, or any combination thereof. Motors 110, 110′ are also connected to a rechargeable battery (FIG. 5A), and the motors 110, 110′ may recharge the battery during operation thereof.

Preferably, the housing 130 is supported as sprung weight, which provides for a lower center of gravity of the overall vehicle, and less mass and force supported on the wheels, which may affect the handling of the vehicle.

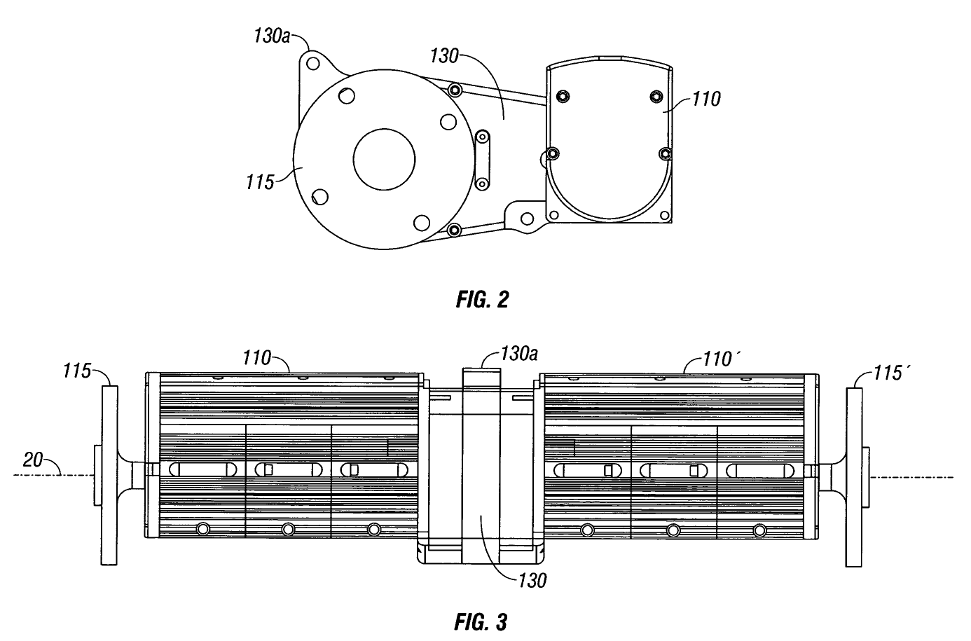

The housing 130 is supported on the vehicle (not shown) and keeps the electric motors 110, 110′ supported correctly, and, thus, oriented in the upright position as shown in FIGS. 2 and 3. Turning to FIG. 4, there is shown a top view of the differential 100. Preferably, the length of the first and the second electric motors 110, 110′ do not exceed the length of the drive axles 105, 105′ so the first and the second electric motors 110, 110′ do not extend past the respective wheels 115, 115′ in operation to prevent the electric motors 110, 110′ from being accidentally damaged during motion of the vehicle V. It is envisioned that motors 110′, 110 can be supported in other orientations including perpendicular to axis 125 with a geared arrangement to correctly provide torque to the respective wheels 115, or 115′.

Turning now to FIG. 5A, there is shown an exploded view of the differential 500 including a first motor 510 and a second motor 510′ spaced away from a housing 530. Each motor 510, 510′ include a motor output shaft 510a, 510a′, which interfaces with a respective first gear 550a, 550a′ through respective apertures located in the center of the gears 550a, 550a′. The first electric motor 510 preferably interfaces with a geared arrangement 600 to multiply the torque and to translate the rotation of the first electric motor 510 to the first drive axle shaft 505. Various gear configurations are possible and within the scope of the present disclosure, and the present gear arrangement 600 is simply illustrative, and it should be appreciated that depending on the vehicle application, the geared arrangement 600 may vary substantially.

In this embodiment, the first gear 550a of the geared arrangement 600 interfaces, or meshes with a second drive gear 550b. Second drive gear 550b includes a smaller third change gear 550c which is connected to second drive gear 550b (FIG. 5B). Third drive gear 550c interfaces or meshes with fourth drive gear 550d. The change gear 550d is connected to an adjacent change gear 550f and drives gear 550e. The first drive axle 505 also includes a splined end 505a that is disposed through the drive hub 555a, and which engages the gear 550e as shown in FIG. 5B. Stationary idler shaft 550g supports gear 550d, and stationary idler shaft 550i supports gear 550b and 550c. The splined end 505a is used as a coupling to couple at least two cylindrically shaped portions similar to a straight gear.

Housing 530 includes a first portion 530a, a second intermediate portion 530b, and a third portion 530c shown in an exploded view, and shown spaced away from one another. These portions make up the housing 530. First portion 530a, second intermediate portion 530b, and the third portion 530c of the housing 530 may be connected by fasteners, such as, for example, a number of bolts, or any other rigid connector known in the art. The second portion 530b is preferably a center support plate, and the first and the third portions 530a, and 530c are preferably side cases. Preferably, first portion 530a, second intermediate portion 530b, and the third portion 530c house the geared arrangement 600, and also support the first and the second electric motors 510, 510′ in a rear of the first and the second drive axles 505, 505′.

The first portion 530a is a resilient member that includes a first aperture 535a for receiving the first drive axle 505, and that also includes a second aperture 540a in the rear of the first aperture 535a. The second aperture 540a is spaced from the first aperture 535a and receives the motor output shaft 510a of the first electric motor 510. Likewise, the third portion 530c also is a resilient member, which includes a first aperture 535a for receiving the second drive axle, and a second aperture 540a for receiving the motor output shaft 510a′ of the second electric motor 510′.

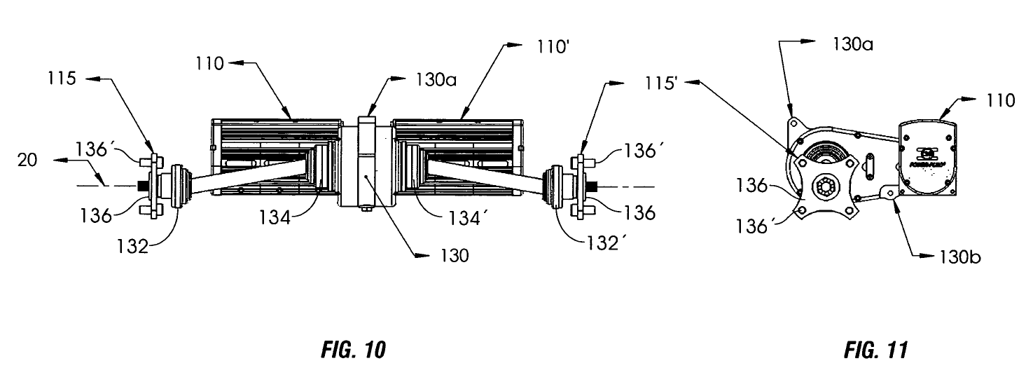

Aperture 535a of the first portion 530a of the housing 530 and aperture 535a of the third portion 530c of the housing 530 are sealed by respective seals 535b, 535b′. Seals 535b, 535b′ are generally circular shaped members, and prevent matter such as dust and dirt from entering the housing 530 during operation of the vehicle. CV joints 132, 134 are also envisioned as shown in FIG. 9, however this arrangement is not limiting.

Disposed on the opposite side, or located between the second intermediate portion 530b, and the third portion 530c, there exists a second geared arrangement 600′ that is disposed generally in a mirror image to the geared arrangement 600 located between the first portion 530a of the housing 500 and the second intermediate portion 530b. Second geared arrangement 600′ may include various different geared configurations depending on the particular vehicle and electric motor, 510, 510′, and the second geared arrangement 600′ is merely being shown as one illustrative embodiment to translate the rotational energy from the second motor 510′ to torque for the second drive axle 505′ in a controlled manner. Preferably, the second geared arrangement 600′ translates the rotational mechanical energy to an increased torque, and then applies this increased torque to the second drive axle 505′ to rotate the second drive axle 505′ about the first rotational axis 120 shown in FIG. 1 in a controlled manner. Geared arrangement 600, 600′ can have a 21:1 ratio, or any ratio from between 1:75 to 30:1. Preferably, the width and pitch of the geared arrangement as the gear set progresses increases the torque requirement.

In this embodiment, the second geared arrangement 600′ includes gear 550b′ which interfaces with a motor output shaft 510a′ of the second electric motor 510′ which is shown attached to the shaft 510a′, and operates in the same manner as geared arrangement 600, but in an independent manner relative to the other motor 510. Turning now to FIG. 5B, there is shown an enlarged view of the geared arrangement 600 from FIG. 5A, from a top view. Gear 550b is connected to gear 550c. Gear 550c is a change gear. The change gear 550c preferably has a hollow bore needle bearing. Gear 550c drives gear 550f, which also is a change gear 550f, and rolls on the idler shaft 550g. Change gear 550f drives gear 550e, which is connected to hub portion 555a, and splined end 505a plugs into hub portion 555a. Thus, one electric motor 510 may independently drive one wheel 115. Geared arrangement 600′ operates in an independent but similar arrangement to drive wheel 115′.

In this manner, controlled operation of each wheel 115, 115′ is achieved, and a controller 610 may be operatively connected to the first electric traction motor 510 along lead 610a, and also may be operatively connected to the second electric motor 510′ along lead 610b. The controller 610 can also be connected to a throttle of the vehicle, or a throttle position sensor 615, or alternatively it may be connected to another sensor, or a combination of sensors. Controller 610 is connected to the rechargeable battery 620, which may be similarly supported as sprung weight. Controller 610 may operate the first electric motor 510 and the second electric motor 510′ at different speeds, or at the same speed depending on the throttle position sensor 615. The controller 610 may also control the first and the second electric motors 510, 510′ based on an output of another sensor, such as a sensor that determines a speed of a wheel. Controller 610 can, thus, determine whether the wheel 115 or 115′ is slipping because of a slick surface. Controller 610 may increase an amount of current supplied to the first or the second electric motors 510, 510′ from battery 620. This may increase a rate of rotation of an individual motor output shaft 505, 505′ to thereby increase the speed of an individual wheel 115, 115′. In this manner, the first electric motor 510 may rotate the first motor output shaft 510a along the second axis of rotation 125 (FIG. 1) at a first rate of rotation. At the same time, the controller 610 controls the second electric motor 510′ to rotate the second motor output shaft 510a′ along the same axis of rotation 125 but at a second rate of rotation, which is different than the first rate of rotation.

Referring again to FIG. 5A, similarly, the second electric motor 510′ will receive a control signal from the controller 610 to rotate the second motor output shaft 550a′ at the second rate of rotation (which is different than the first rate of rotation). In this manner, the second electric motor 510′ may rotate the second motor output shaft 510a′ along the second axis of rotation 125 (which is shown in FIG. 1). The second motor output shaft 510a will rotate geared end 550a′ (which has the same arrangement as discussed for FIG. 5B). This rotates the second drive axle 505′, and the attached wheel 115′, at a second rate of rotation. This rotation may account for surface condition, or a throttle position.

This control advantageously mimics an automobile differential. Control may be in response to a turn, or other sensed condition such as a detected wheel slipping, where it is desired to rotate one of the wheels 115, 115′ at a different rate of rotation relative to the other wheel 115, 115′. Control can also be to provide different traction, or even for steering assistance. This advantageously occurs without the costly apparatuses of a spider gear type differential.

In another embodiment, the controller 610 may control the first electric motor 510 to rotate at the same rate of rotation as the second electric motor 510′ by supplying electrical power to the first and the second electric motors 510, 510′ from the battery 620. Various battery 620 configurations are possible and within the scope of the present disclosure, and nickel cadmium batteries, nickel metal hydrides, or lithium ion batteries may be used, or other rechargeable batteries known in the art.

Preferably, the differential 500 includes two independent motors, with a geared arrangement 600 that is independent relative to a second geared arrangement 600′, and geared arrangement 600 is not connected in any manner to the geared arrangement 600′. Preferably, the idler shafts 550g and 550i have a flat 550h that fits in the housing 530, and that prevents the idler shafts 550g and 550i from rotating. Flat 550h can receive a key 580 which connects to housing 530a by pins 580b and 580c. Preferably, housing 530 can be mounted to the suspension by post 535a′, which connects to the vehicle (not shown) and that prevents rotation of the differential 500.

Turning now to FIG. 6A, the present disclosure may be configured to provide traction to four wheels, and be used for all wheel drive operation, such as, for example, in connection with a four wheel drive vehicle. As shown, the differential 650 may include a first differential assembly 650a, and a second differential assembly 650b with the first differential assembly 650a including a first electric motor 660a and a second electric motor 660b and with the second assembly 650b including a third electric motor 660c and a fourth electric motor 660d. In this manner, a four wheel drive vehicle may include electric motors 660a through 660d with each corresponding to a wheels 670a through 670d of the vehicle. Each motor 660a through 660d may be individually controlled. This provides selective torque to each axle shaft 680a through 680d. Each of the first through fourth electric motors 660a through 660d is operatively connected to a controller 690, which is also operatively connected to a battery 695, or power supply, and a sensor 700. The sensor 700 may be a throttle position sensor 700a. Other sensors are envisioned which measure a speed or various parameters of each wheel. Parameters can include such as, for example, speed of a particular wheel over an average speed of all wheels to determine whether a wheel is slipping.

In response to the throttle position sensor 700, the controller 690 may control each motor 660a through 660d or may control selective motors 660a through 660d. Some motors (first and third) may operate at a different rate of rotation relative to others (the second and the fourth electric motors 660b, 660d). This can be for example, during turning or in response to a position of the throttle position sensor 700, or in response to other sensors that determine whether slip of an individual wheel in time is occurring.

Various sensor and control configurations are possible and within the scope of the present disclosure. It is envisioned that the present electric motors 660a through 660d can be controlled by a controller 690. Controller 690 which can include program instructions to receive multiple inputs from multiple different sensors and then control the electric motors 660a through 660d accordingly based on the sensory input. It should be appreciated that each electric motor 660a through 660c is supported by the first and the second housings 705a, 705b as sprung weight. Preferably, they are supported in a low location under the vehicle. In all embodiments, motors 660a-660d can provide different rotational speeds, and when combined with drives, and a controller 690, motors 660a-660d can provide equal torque, provide torque to an axle that has traction, can provide proportional torque to axles with different degrees of traction, or can provide steering assistance. The motors 660a-660d can also maintain equal rotational speeds when operating on non-uniform, unstable surfaces, and can continuously provide torque to all wheels proportionally to the individual wheel's level of traction.

Turning now to FIG. 6B, there is shown an alternative embodiment of the present disclosure. In this embodiment, the present differential 650 is not limited to two housings 705a, 705b to support the first through fourth electric motors 660a through 660d as sprung weight, and as shown in FIG. 6B. Here, differential 650 instead is differently configured. First through fourth electric motors 660a through 660d are supported on one housing 705c. A first through fourth gear arrangements (not shown) may also be provided as described above for FIG. 5A, or alternatively include another different geared arrangement supported therein. This provides for a suitably and sturdy assembly, and ease of installation.

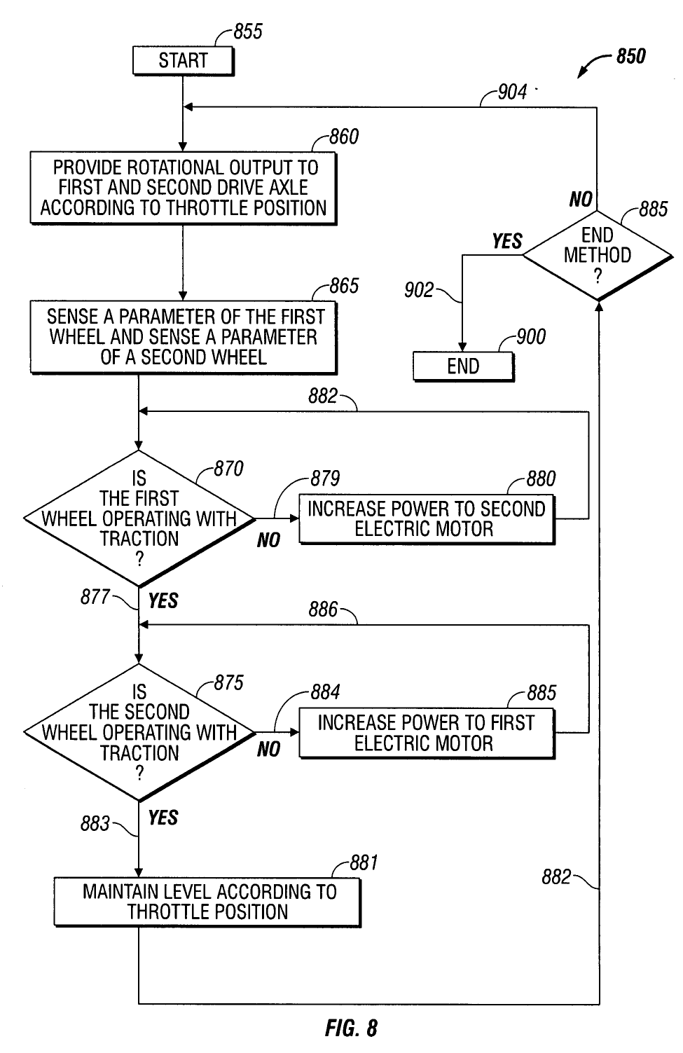

Turning now to FIG. 7, there is shown another preferred embodiment of the present disclosure. In this embodiment, instead of being configured as a differential for a vehicle, the present apparatus 750 is configured to mimic a transmission for a non-differential vehicle. As shown, the transmission generally represented by reference number 750. Transmission 750 may include a first electric motor 760a, and a second electric motor 760b operatively connected to the controller 770. The controller 770 is also operatively connected to a battery 775, which is also connected to the first and the second electric motors 760a, and 760b. Battery 775 may be rechargeable by motors 760a, 760b during operation thereof. The transmission 750 may use any electric motors 760a, and 760b such as, for example, any switched reluctance motors, permanent magnet electric motors, alternating current synchronous electric motors, servo-electric motors, induction electric motors, brushless, permanent magnet, direct current motors, or any combination thereof, and may use the same type of electric motor 760a, 760b, or may use different types of electric motors 760a, 760b for the apparatus 750.

Generally, the apparatus 750 operates as an automotive transmission by supplying a predetermined rotational output A to the drive axle 790a, and a predetermined rotational output B to the drive axle 790b to provide a predetermined amount of traction output to the wheels 800a, 800b with a suitable drives and a controller. The rotational outputs A, B. can depend on sensed parameters from a sensor, such as a throttle position sensor 800c or rotational outputs may be from fixed settings which are output from the controller 770. Controller 770 can receive an output from the throttle position sensor 800c, and has program instructions stored on a memory 800d to output a control signal. This allows a predetermined amount of power to be supplied from the battery 775 and to the first and the second electric motors 760a, 760b over time. Depending on the position of the throttle 800c, the motors 760a, 760b will provide a selective amount of rotational energy as shown by reference letters A, B to the drive axles 790a, 790b. This in turn, drives a desired torque output to the wheels 800a, 800b.

In this embodiment, the transmission 750 includes a transmission gearbox housing 780. The first and the second electric motors 760a, 760b extend from the housing 780. The first and the second drive axles 790a and 790b also extend from the housing 780 on opposite sides as discussed with regard to the embodiment of FIG. 1. The transmission 750 also includes a similar or different geared arrangement than that which is disclosed in FIG. 5A. This geared arrangement multiplies the torque from the selective rotational output of the respective first and the second electric motors 760a, 760b to deliver this torque to the first and second drive axles 790a, 790b. It is envisioned that in another exemplary embodiment, that only one motor 760a is used. However, this configuration is optional and is less preferred, and does not form any limitations to the present invention. The geared arrangement (not shown) may then translate the rotational output of the one motor 760a to both drive axles 790a, 790b, and the present apparatus 750 is not limited to two motors 706a, 706b.

Additionally, the controller 770 may output a control signal to the first and the second electric motors 760a, 760b. This signal may control the speed of each wheel 800a, 800b as the vehicle drives by selectively supplying an amount of current from battery 775 to the first and the second electric motors 760a, 760b. This, in turn, controls motors 760a, 760b to output a predetermined mechanical rotation force, which is then translated to the first and the second axles shafts 790a, 790b, and to the respective wheels 800a, 800b. It should be appreciated that the housing 780, and the first and the second electric motors 760a, 760b, are supported as sprung weight, and the housing 780 can be connected at location 780a to a vehicle, such as, for example, an all terrain vehicle, or ATV. Alternatively, other connection points are envisions such as, for example those shown in FIG. 5B.

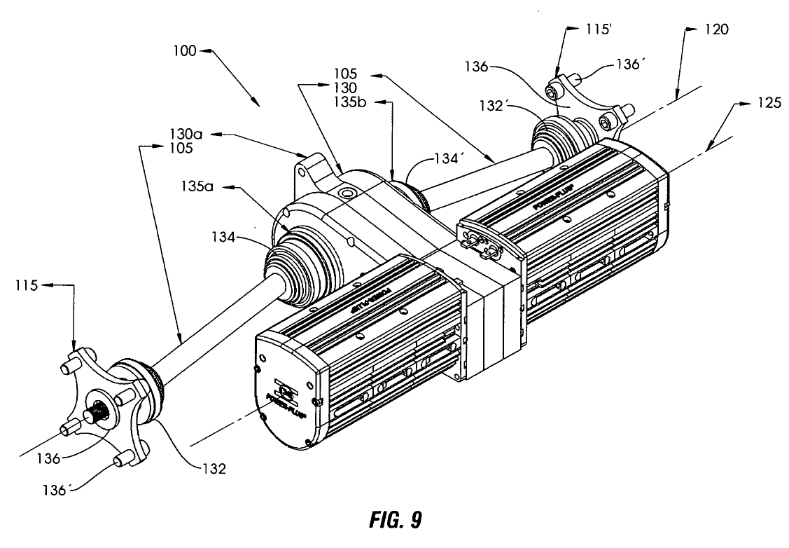

Turning now to FIG. 8, a method of controlling the first and the second electric motors 110, 110′ to mimic a differential for a vehicle is shown and described. It should be appreciated that the method 850 is not limiting, and the method 850 may be used with various sensor configurations, including as little as no sensors, or multiple sensors which measure one or various parameters of the vehicle, such as the speed, throttle position, average, wheel speed, or other sensed parameters. The method commences at step 855, and then proceeds to step 860. At step 860, the method 850 includes the step of providing a rotational output to the first and the second drive axles as shown in FIG. 1. In one embodiment, the drive output generally may be proportioned, or otherwise set by a throttle position.

The method 850 then continues to step 865 to sense a parameter of the first wheel, and to sense a parameter of a second wheel. It should be appreciated that various parameters may be sensed including a wheel speed of each wheel, a tire slipping, a throttle position, or multiple “slip-indicating” parameters may be sensed. It should be appreciated that in four wheel operation, such as disclosed in FIGS. 6A and 6B, parameters of all four wheels may be sensed, and the present disclosure is not limited to any sensing with respect to a two wheel, or a four wheel configuration, and is intended to cover such embodiments. It should also be appreciated that the first and second parameters can be sensed simultaneously, or in any order, and the method 850 is not limited to any specific hierarchical order. The method 850 then continues to step 870, where a decision block occurs. At step 870, the method 850 decides whether the first wheel is operating with traction. If an affirmative is reached, and the first wheel is correctly operating with traction at step 870, then control of the method passes to step 875 along line 877.

If a negative is reached at step 870, and the first wheel is not operating with traction at step 870, then control of the method 850 passes to step 880 along line 879. In order to remedy that the first drive is not operating with traction, the method 850 may increase power (current) to the second electric motor at step 880 so as to permit the first wheel to regain traction. Other conditions are also possible, such as decreasing power to the first wheel at step 880 instead of, or in addition to, increasing power to the second electric motor at step 880. Various control configurations to regain traction are possible and within the scope of the present disclosure and the present method may include other steps, not shown here. Thereafter, at the conclusion of step 880, control passes back from step 880 to step 870 along lead 882 to determine whether the first wheel is operating with traction.

If an affirmative is reached at step 870, then control passes along line 877 to step 875. At step 875, the method 850 decides whether the second wheel is operating with traction. If an affirmative is reached, and the second wheel is operating with traction at step 875, then control of the method passes to step 881 along line 883.

If a negative is reached at step 875, and the second wheel is not operating with traction at step 875, then control of the method 850 passes to step 885 along line 884. In order to remedy that the second wheel is not operating with traction, the method 850 may increase power (current) to the first electric motor at step 885 so as to permit the second wheel to regain traction. Other conditions are also possible, such as decreasing power to the second wheel at step 885 instead of, or in addition to, increasing power to the first wheel. At the conclusion of step 885, control passes back from step 885 to step 875 along lead 886 to determine whether the second wheel is operating with traction.

If an affirmative is reached at step 875, then control passes along line 883 to step 881. At step 881, the method 850 has determined that both wheels are operating with traction and maintains levels according to a vehicle throttle position. Then, control of the method 850 passes along line 882 to step 885. At step 885, it is determined whether the method 850 should be ended, and if yes, control passes to step 900 along line 902, and if the vehicle is still in operation, the method proceeds to step 860 along line 904 to continue providing output to the first and the second drive axle at step 860 according to a throttle position.

Various traction control configurations are possible and within the scope of the present disclosure to control the first and the second electric motors differently, and in response to one or more sensed parameters. The presently described method 850 is intended to encompass those embodiments, and is not limited to any particular method, and the method 800 disclosed herein is for illustrational purposes only. It is envisioned that the sensed parameters may include wheel speed, wheel slippage, tire pressure, a ratio of wheel speed to average speed of all tires, acceleration, positional information, or any other sensed parameters. Controller uses this information to determine whether different rotational outputs from electric motors 110, 110′ are necessary, and supplied to drive the first and the second drive axles 105, 105′ of FIG. 1.

Preferably, the present differential 500 provides for two motors 510, 510′ to provide differential action without having the costly spider gears and one motor 510 can lead or lag the other electric motor 510′ and give the same effect as a conventional spider gear differential assembly.

Turning now to FIGS. 9-11, there is shown another alternative embodiment of the present disclosure. In this embodiment, the differential 100 is formed with joints 132, 134 with one constant velocity (“CV”) joint 132 connecting the drive axle 105 with a wheel support 136, and a second CV joint 134 connecting the housing 130 with the drive axle 105. Another pair of CV joints 132′, 134′ are supported on the opposite drive axle 105′. The CV joints 132, 132′, and 134, 134′ prevent jerky movement and provides for consistent drive axle speeds regardless of the operating angle of the respective joint. The CV joint 132, 132′, 134, and 134′ may alternatively be made as suitable ball type joints or tripod joints. Wheel support 136 preferably includes studs 136′ to engage a wheel (not shown). It should also be appreciated that in yet another non-limiting embodiment, one electric motor 110 or 110′ shown in FIG. 1 may drive two wheels 115 and 115′. In this embodiment, the splined end 505a that plugs into drive hub 555a is large enough to extend a sufficient amount to drive both axles 505, 505′ and one set of the two geared arrangements 600, and 600′ shown in FIG. 5A may be omitted.

The teachings of all patents, published applications and references cited herein are incorporated by reference in their entirety. While this invention has been particularly shown and described with references to example embodiments thereof, it will be understood by those skilled in the art that various changes in form and details may be made therein without departing from the scope of the invention encompassed by the appended claims.

What is claimed is:

1. A differential for a vehicle having a suspension, the differential comprising:
a first axle shaft;
a second axle shaft;
the first axle shaft and the second axle shaft being disposed along a first axis of rotation;
a first electric motor being disposed along a second axis of rotation and spaced from the first axis; and
a housing configured to support the first and second axle shaft in a transverse manner through the housing, the first electric motor also being disposed in a transverse manner through the housing, the housing configured to support the first electric motor as sprung weight.

2. The differential as claimed in claim 1, further comprising:
a second electric motor with the first and the second electric motors being disposed along the second axis of rotation, and spaced from the first axis; and
the first and second electric motors being disposed in a transverse manner through the housing with the housing configured to support the first and the second electric as sprung weight.

3. The differential as claimed in claim 2, wherein at least one of the first electric motor and the second electric motor are switched reluctance motors, permanent magnet electric motors, alternating current synchronous electric motors, servo-electric motors, induction electric motors, brushless direct current motors, or any combination thereof.

4. The differential as claimed in claim 2, further comprising a controller configured to independently control the first and the second electric motors relative to one another.

5. The differential as claimed in claim 4, wherein the controller receives an input signal from a sensor, and is configured to independently control an output of the first and the second electric motors relative to one another to mimic an automotive mechanical differential.

6. The differential as claimed in claim 5, wherein the input signal is received from a throttle position sensor.

7. The differential as claimed in claim 2, further comprising:
a third axle shaft and a fourth axle shaft being disposed along a third axis of rotation;
a third electric motor and a fourth electric motor being disposed along a fourth axis of rotation, the fourth axis being spaced from the third axis; and
the third and the fourth axle shafts disposed in a transverse manner through the housing, the third and fourth electric motors also being disposed in a transverse manner through the housing, the housing configured to support the first through fourth electric motors as sprung weight, and configured for four wheel drive operation.

8. The differential as claimed in claim 7, wherein at least one of the third electric motor and the fourth electric motor are switched reluctance motors, permanent magnet electric motors, alternating current synchronous electric motors, servo-electric motors, induction electric motors, brushless direct current motors, or any combination thereof.

9. The differential as claimed in claim 8, further comprising:
a controller configured to receive an input signal from a sensor, and configured to independently control an output of the first through fourth electric motors to mimic an automotive mechanical differential.

10. The differential as claimed in claim 7, wherein the third and fourth electric motors are independently controlled relative to one another.

11. The differential as claimed in claim 7, further comprising:
a second housing spaced from the housing, the third and the fourth axle shafts disposed in a transverse manner through the second housing instead of the housing, and the third and fourth electric motors also being disposed in a transverse manner through the second housing instead of the housing, the second housing configured to support the third and fourth electric motors as sprung weight with four wheel traction operation.

12. The differential as claimed in claim 1, wherein the first electric motor is operatively connected to the first axle shaft by a geared arrangement configured to be a torque multiplier.

13. The differential as claimed in claim 7, wherein the third electric motor is operatively connected to the third axle shaft by a geared arrangement configured to be a torque multiplier, or wherein the fourth electric motor is operatively connected to the fourth axle shaft by a second geared arrangement configured to be a torque multiplier.

14. The differential as claimed in claim 1, further comprising:
a rechargeable battery operatively connected to the first electric motor and configured to store electric power.

15. The differential as claimed in claim 2, wherein the first and second electric motors are brushless direct current electric motors.

16. A differential for a vehicle having a suspension, the differential comprising:
a first axle shaft;
a second axle shaft;
the first axle shaft and the second axle shaft being disposed along a first axis of rotation;
a first electric motor;
a second electric motor;
the first and the second electric motors being disposed along a second axis of rotation spaced from the first axis and located in a rear of the first and second axle shafts with the first and second electric motors being generally parallel with regard to the first axle shaft and the second axle shaft; and
a housing with the first and second axle shaft disposed in a transverse manner through the housing, the first and second electric motors being disposed in a transverse manner through the housing, the housing configured to support the first and the second electric motors, the first and second electric motors being supported underneath the vehicle as sprung weight.

17. The differential as claimed in claim 16, further comprising a constant velocity joint connecting at least one of the first or second axle shaft to a geared assembly, the geared assembly being connected to at least one of the first, and second electric motor.

18. A method of transmitting power to at least a first and second wheel and allowing the first and second wheels to rotate at different speeds relative to one another, the method comprising:
providing a first axle shaft connected to the first wheel;
providing a second axle shaft connected to the second wheel with the first axle shaft and the second axle shaft being disposed along a first axis of rotation;
supporting the first and second axle shaft in a transverse manner along the first axis of rotation;
providing at least one electric motor disposed along a second axis of rotation spaced from the first axis of rotation; and
supporting the first electric motor transversely and spaced from the first and the second axle shaft so that the electric motor is supported as sprung weight relative to the suspension.

19. A transmission for a single wheel of a vehicle having a suspension, the transmission comprising:
a first axle shaft;
a second axle shaft;
the first axle shaft and the second axle shaft being disposed along a first axis of rotation;
a first electric motor being disposed along a second axis of rotation spaced from the first axis, and connected to the first axle shaft by a geared arrangement;
a housing supporting the first and second axle shaft in a transverse manner through the housing;
the housing supporting the first electric motor in a transverse manner through the housing with the housing being configured to support the first electric motor as sprung weight relative to the suspension;
a battery operatively connected to the first electric motor and a controller, the controller receiving at least one input signal relating to a parameter of the vehicle; and
the controller receiving the at least one input signal, and outputting a control signal in response thereto to control an output of the first electric motor, the first electric motor in response to the control signal rotating the geared arrangement to rotate at least one of the first axle shaft or the second axle shaft at a predetermined rate of rotation depending on the input signal.

20. The transmission as claimed in claim 19, wherein the input signal is received from a throttle.

21. The transmission as claimed in claim 19, further comprising:
a second electric motor with the first and the second electric motors being disposed along the second axis of rotation, and spaced from the first axis of rotation; and
the first and second electric motors being disposed in a transverse manner through the housing with the housing configured to support the first and the second electric motors, the first and second electric motors being supported as sprung weight; and
the controller receiving the at least one input signal, and outputting the control signal in response thereto to control the output of the second electric motor, the second electric motor in response to the control signal rotating a second geared arrangement connected to the second axle shaft to rotate the second axle shaft in a controlled manner.

22. The transmission as claimed in claim 19, wherein at least one of the first electric motor and the second electric motor are switched reluctance motors, permanent magnet electric motors, alternating current synchronous electric motors, servo-electric motors, induction electric motors, brushless direct current motors, and any combination thereof.

23. A differential for transportation device comprising;
a first axle shaft;
a second axle shaft;
a first electric motor;
a second electric motor;
a housing having the first and second electric motors aligned and spaced from the aligned first and second axle shafts; and
a controller configured to control the first and second electric motor to electronically mimic a differential by selectively providing power supplied to each of the first and second electric motors.
